(19) United States
(12) Patent Application Publication
(10) Pub. No.: US 2024/0006908 A1
(43) Pub. Date: Jan. 4, 2024

(54) APPARATUS AND/OR SYSTEM FOR PROVIDING PULSATING BUFFER CONVERTER WITH A BOOST CIRCUIT

(71) Applicant: Lear Corporation, Southfield, MI (US)

(72) Inventors: Rafael JIMENEZ PINO, Valls (ES); Hector SARNAGO ANDIA, Olvega (ES); Oscar LUCIA GIL, Zaragoza (ES); Pablo GAONA ROSANES, Valls (ES); Ruben MOLINA LLORENTE, Valls (ES); Antonio MARTINEZ PEREZ, Valls (ES)

(21) Appl. No.: 17/853,242

(22) Filed: Jun. 29, 2022

(51) Int. Cl. H02J 7/02; H02J 7/34; H02M 1/14; H02M 3/335; B60L 53/55; B60L 53/20

(52) U.S. Cl. CPC H02J 7/02; H02J 7/345; H02M 1/14; H02M 3/33576; B60L 53/55; B60L 53/20; H02J 2207/20; B60L 2210/14

(57) ABSTRACT

In at least one embodiment, a battery charger is provided. The battery charger includes at least one transformer, a first active bridge, a second active bridge, and a pulsating buffer (PB) converter. The first active bridge is positioned on a first side of the transformer to provide a first voltage signal based on an input voltage signal from a mains supply of an electrical grid. The second active bridge is positioned on a second side of the transformer to provide a second voltage signal to store on one or more batteries based on the first voltage signal. The PB converter includes a plurality of switching devices to interface with the second active bridge to modify the second voltage signal. The plurality of switching devices provide a voltage for storage on at least one capacitor of the PB converter while modifying the second voltage signal.

### TECHNICAL FIELD

Aspects disclosed herein generally relate to an apparatus and/or system that includes a pulsating buffer (PB) converter including a boost circuit. In one example, the disclosed PB converter and the boost circuit may be implemented for vehicle applications. These aspects and others will be discussed in more detail herein.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts a block diagram of an electrical system having an on-board charger (OBC);

FIG. 2 depicts one example of an apparatus for an on-board charger (OBC) including an integrated PB converter;

FIG. 3 depicts another example of the apparatus for the OBC including the integrated PB converter;

FIG. 4 depicts an apparatus for the OBC with the integrated PB converter in accordance with one embodiment; and

FIG. 5 depicts a plot exhibiting a voltage output associated with the OBC that varies based on time in accordance with one embodiment.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Aspects disclosed herein generally provides, but not limited to, an on-board charger that includes a pulsating buffer (PB) converter. The PB converter is generally configured to interface with an active bridge circuit on a secondary side of the OBC to eliminate current ripple from a voltage signal for generating a smoothed output signal that is suitable for storage on one or more vehicle batteries. In general, current consumers have single vehicle OBC platforms that use either 400V or 800V. Current OBC solutions may be expensive when handling an output from 350V for 800V. In one example, the PB converter utilizes a capacitance that operates to a maximum of half of a minimum voltage output (e.g., 175 Vdc). However, such an implementation with respect to overall capacitor(s) may necessitate high capacitance values and a larger packaging size for the capacitors. For example, the energy that any capacitor may store is ½·C·V². Thus, for the same energy that may be needed, if the voltage is lower, then the capacitance should be higher. Aspects disclosed herein generally provide a PB converter that includes a boosting circuit. The boosting circuit increases a working voltage for the capacitance of the PB converter. In this case, it is possible to increase the output operation range for the OBC to operate up to 800V while utilizing component values for the capacitance that may be generally used to provide a 400V based output for the OBC. The boosting circuit of the PB converter may (i) reduce component size (e.g., less capacitance) than conventional implementations (ii) enable for a wider output voltage operation range into lower voltage values for the OBC, and (iii) enable the alignment with current market offerings (e.g., design technology harmonization) and other 400V-OBC variants.

Based on the aspects disclosed herein, the voltage stored on the capacitor in the PB converter is now independent from the overall voltage output provided by the OBC. This may be generally attributed to the boosting stage as set forth herein. Thus, it is no longer necessary to consider the capacitor voltage to be half of the minimum value of the final output of the OBC (e.g., 175 Vdc). In addition, the capacitance of the PB converter for an 800V based OBC variant, may now be similar to the capacitance of a 400V based OBC variant which is generally operated at a higher voltage value than conventional OBCs. Similarly, by providing a capacitor to store a high voltage to withstand 800V, it is possible to meet energy needs for the OBC while enabling a low capacitance value which yields smaller and less expensive components. By providing smaller and less expensive components, the disclosed OBC may meet OBC requirements while utilizing Original Equipment Manufacturers (OEM) platforms with vehicles using, for example, 400V or 800V batteries with the same OBC product.

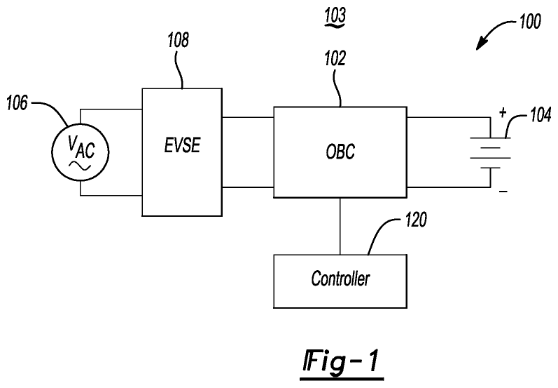

FIG. 1 generally illustrates a block diagram of an electrical system 100 having an on-board charger (OBC) 102. One example of an OBC is set forth in in pending U.S. application Ser. No. 16/731,106 (“the '106 application”) entitled “ON-BOARD CHARGER (OBC) SINGLE-STAGE CONVERTER” as filed on Nov. 13, 2019; the disclosure of which is hereby incorporated by reference in its entirety. The OBC 102 is generally positioned “on-board” an electric vehicle 103. The term “electric vehicle” herein may encompass any type of vehicle which uses electrical power for vehicle propulsion and encompasses battery-only electric vehicles (BEV), hybrid electric vehicles (HEV), plug-in hybrid electric vehicles (PHEV), and the like. The OBC 102 may be used for charging a traction battery 104 of the electric vehicle 103. The traction battery 104 may be a high voltage (HV) direct current (DC) traction battery as dictated per electrical energy requirements for electric vehicle propulsion.

The electrical system 100 further includes an alternating (AC) power source such as a mains supply 106 of an electrical grid 107. The OBC 102 charges the traction battery 104 using electrical power from the mains supply 106. The OBC 102 includes an input that connects to the mains supply 106, via an external Electric Vehicle Supply Equipment (EVSE) 108, to absorb electrical power from the mains supply 106. The OBC 102 includes an output that connects to the traction battery 104. The OBC 102 converts electrical power absorbed from the mains supply 106 into DC electrical power and charges the traction battery 104 with the DC electrical power.

A controller 120 is operably coupled to the OBC 102. The controller 120 may be an electronic device such as one or more processors, one or more micro-controllers, or the like (e.g., a computer) that is positioned on-board the electric vehicle 103. The controller 120 may be defined as a vehicle controller. The controller 120 is operably coupled to the OBC 102 to control operations of the OBC 102. The controller 120 controls the OBC 102 to convert electrical power from the mains supply 106 into DC electrical power and charging traction battery 104 with the DC electrical power. For example, the controller 120 selectively controls switching and switching duration of power switches (not shown) positioned in the OBC 102. The power switches may be used to convert electrical power received from the mains supply 106 into a predetermined amount of DC electrical power. The controller 120 may communicate and control other nodes of the electrical system 100 and the electric vehicle 103 including nodes involved in the charging applications. It is recognized that the OBC 102 may be bi-directional and energy may flow from the battery 104 to the grid 107 through the OBC 102.

In general, the OBC 102 may include a single stage architecture having a dual active bridge (DAB) configuration (not shown). In various embodiments, a transformer may be positioned between two H-bridge stages. After initial AC input filtering and rectification is performed at the OBC 102, one portion of the H-bridge stage as positioned on a primary side of the transformer chops a signal at an intermediate frequency (e.g., 100 kHz) so that the transformer may then transmit the chopped signal to a secondary side of the transformer (e.g., to a second portion of the H-bridge). The second portion of the H-bridge converts the chopped signal into a DC output with some ripple. A pulsating buffer (PB) converter may be integrated with second H-bridge to compensate for the ripple, thereby enabling at least a flat DC output (e.g., in voltage and current) to charge the battery 104. An output filter stage may be provided to eliminate high-frequency noise to ensure electromagnetic compliance in the vehicle HV network.

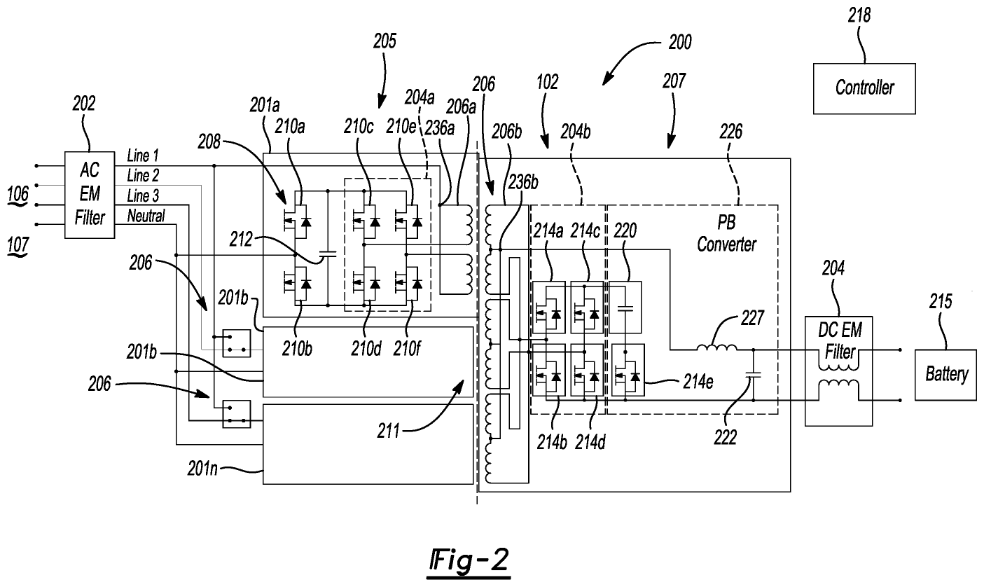

FIG. 2 depicts an apparatus 200 for the OBC 102 (e.g., 11 kW 400V variant) with a pulsating buffer (PB) converter 226. The apparatus 200 generally includes a plurality of modular converters 201a-201n (or “201”). Each corresponding modular converter 201 includes the rectifying half bridge structure 208 and the DAB stages 204a, 204b. Each of the modular converters 201 also includes one transformer 206 (e.g., a single transformer 206 with two primary windings 206a (or primary-side transformer 206a) positioned on the primary side 205 and two or more secondary windings (or secondary-side transformer 206b) positioned on the secondary side 207, and the PB converter 226. In general, there is one transformer 206 per modular converter 201 and each transformer 206 includes a primary with two coils or windings 206a (with a middle point 236a) (or the two primary windings 206a) and a secondary with two coils or windings 206b (with a middle point 236b) (or the two secondary windings 206b). FIG. 2 illustrates the details for the modular converter 201a which includes the primary transformer 206a and the secondary transformer 206b and a number of other features. While FIG. 2 illustrates the additional modular converters 201b-201n, it is recognized that each of these modular converters 201b-201n include similar features to that depicted as shown in the modular converter 201a. It is recognized that the primary windings 206a is only illustrated for the modular converter 201a and is not illustrated for the remaining modular converters 201b-201n. Similarly, it is recognized that the secondary windings 206b is illustrated in FIG. 2 for all modular converters 201a-201n.

The apparatus 200 includes a first filter 202 and a second filter 204. The first filter 202 is operably coupled to a primary side 205 of each converter 201. The second filter 204 is operably coupled to a secondary side 207 that is common to all converters 201. The first filter 202 may be an AC electromagnetic interference (EMI) filter used to comply with EMC (electromagnetic compatibility) standards. The second filter 204 may be a DC EMI filter used to ensure smooth output current supplied to a battery 215. The second filter 204 may be implemented in a number of OBC designs for the automotive market. It is recognized the number of modular converters 201 implemented in the disclosed apparatus 200 may vary based on the desired criteria of a particular implementation.

Each of the converters 201 includes a plurality of switches 210a-210f (“210”) and a capacitor 212. The switches 210a-210b generally form a rectifier 208. The rectifier 208 is generally coupled to the mains supply 106 to rectify an incoming AC input. The plurality of switches 210 and the capacitor 212 are operably coupled to the primary-side transformer 206a for each the modular converters 201. In operation, the rectifier 208, which includes the switches 210a and 210b, provides a rectified output voltage or current in response to an output provided by the first filter 202. The rectifier 208 provides the rectified output voltage to the primary side 205. One or more controllers 218 (hereafter “the controller 218”) controls the switches 210 to provide a requisite amount of rectified output current associated from the rectified output voltage from the rectifier 208 to generate a primary-side output voltage or current on the primary-side transformer 206a.

The switches 210c-210f (or the first active bridge) on the primary side 205 receive the rectified output voltage/current from the rectifier 208. The controller 218 controls the operation of the primary-side power switch bridge (or the switches 210c-210f) to draw a requisite amount of rectified output current associated with the rectified output voltage from the rectifier 208 and generate therefrom a primary-side output voltage on primary-side transformer 206a. The controller 218 controls the switches 210a-210d to generate a secondary-side input voltage/current on the secondary-side 207 (or on the secondary-side transformer 206b).

The DAB stage 204b includes power switches 214a-214d (or the second active bridge) that are positioned on the secondary side 207. The PB converter 226 includes a switch 214e, capacitors 220 and 222, and an inductor 227. Capacitor 222 is a bus capacitor that is used to decouple electrical devices on the PB converter 226. The PB converter 226 may provide for energy transfer based on magnetic energy stored on the inductor 227 and electrical energy stored on the capacitor 222. This aspect may be controlled based on the manner in which the controller 218 controls the switches. The capacitor 220 is charged with the secondary side input voltage or current which supplements the main energy flow that flows from the primary side 205 to the secondary side 207, or from the secondary side 207 to the primary side 205. The capacitor 220 supplements the main energy flow to reduce or minimize the ripple of the output that is stored on the battery 215. The secondary side 207 provides the primary voltage output that is stored on the battery 215, while the PB converter 226 reduces the ripple associated with the voltage output. The PB converter 226 draws a buffer current associated with a buffer voltage from the capacitor 220 which is provided to the battery 215 via the second filter 204. The controller 218 controls the operation of the power switches 214a-214d. As noted above, the power switches 214a-214d are on the secondary side 207 and switch 214e along with the capacitor 220. Thus, in this regard, a portion of the PB converter 226 (e.g., the switch 214e and the capacitor 220) is combined together with the switches 214a-214d (or the DAB stage 104b) on the secondary side 207. The PB converter 226 draws a requisite amount of buffer current associated with the buffer voltage and generates therefrom a targeted, battery voltage/current. The PB converter 226 generates the required current to eliminate a current ripple that may have a frequency of, for example, 100 to 120 Hz and provides a smooth DC current to the battery 215. In one example, the PB converter 226 minimizes the current ripple on the energy provided by the secondary-side transformer 206b and the DAB stage 204b to deliver a targeted battery voltage/current to charge the battery 215. As noted, above the PB converter 226 is combined with the secondary side 207 (e.g., the switches 214a-214d). The controller 218 employs a control strategy (and control blocks) which enables the control of the PB converter 226 to be integrated with control of the secondary side 207. One example of a control strategy is set forth in pending U.S. application Ser. No. 17/335,661 (“the '661 application”) entitled “APPARATUS FOR SINGLE STAGE ON-BOARD CHARGER WITH AN INTEGRATED PULSATING BUFFER CONTROL” as filed on Jun. 1, 2021, which is hereby incorporated by reference in its entirety. It is recognized the secondary side 207 includes the DAB stages 104b, the transformer secondary 106b, and the PB converter 226.

The apparatus 200 may also be used in connection with a 22 kW, 400V variant (e.g., see FIG. 2) assuming that various values for the electrical devices illustrated on the apparatus 200 are utilized. In this regard, the battery 215 is coupled to a middle point of the secondary-side transformer 206b via the inductor 227 and the capacitor 220 is coupled to a secondary bus (e.g., to the switches 214) which is capable of being charged to at or around, for example, 400V.

It is recognized that the OBC 102 is bi-directional and in one direction (or when the OBC 102 is discharging energy or is in a discharging state), the OBC 102 enables the battery 215 to provide a voltage to the secondary side 207 and energy is delivered back through the primary side 205 to provide an AC output on the electrical grid 107. In the other direction (or when the OBC 102 is in a charging stage (e.g., AC DC conversion to store DC energy on battery 215)), the OBC 102 provides AC energy from the mains supply 106 to the primary side 205 where an AC output is provided therefrom to the secondary side 207 (and the PB converter 226) to generate a DC output for storage on the battery 215.

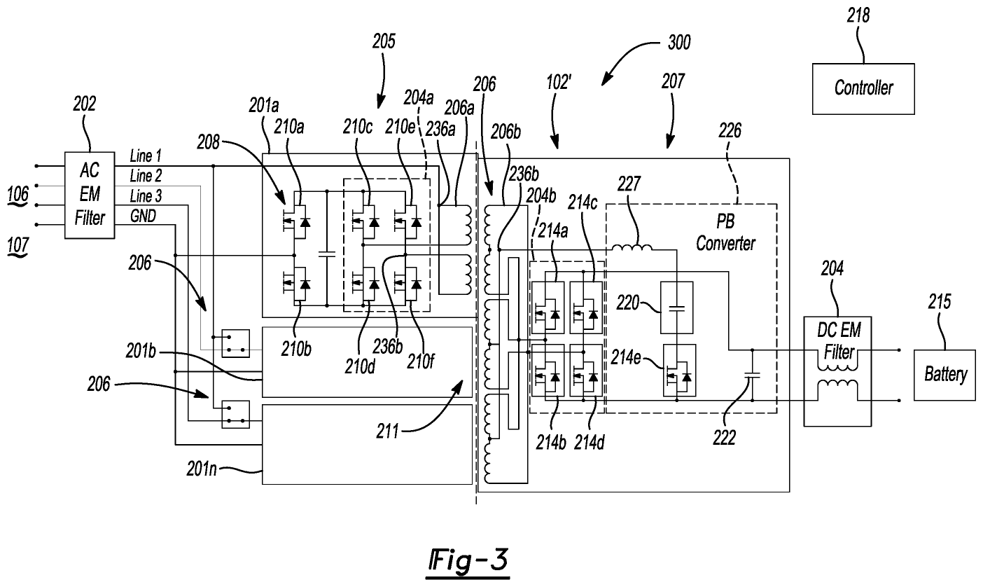

FIG. 3 depicts an apparatus 300 for a single stage OBC 102′ (e.g., 11 kW 800V variant) with the integrated PB converter 226 in accordance with one embodiment. The apparatus 300 is generally similar to the apparatus 200 as described in connection with FIG. 2. The battery 215 is coupled to the secondary bus (e.g., to the switches 214) which differs from FIG. 2. The apparatus 200 of FIG. 2 generally provides an output voltage of 400V whereas the apparatus 300 of FIG. 3 generally provides an output voltage of 800V. The capacitor 220 of the PB converter 226 is coupled to a middle point of the secondary-side transformer 206b on the secondary side 207 via the inductor 227. In one example, the output for the OBC 102′ may be set to 800V. Given that the capacitor 220 is coupled through the inductor 227 to the middle point 236b of the transformer 206, the voltage of the capacitor 220 may be, for example, half of the voltage of the battery 215 with a maximum in the range of 400V. These aspects of FIG. 3 differ from that illustrated in FIG. 2. It is recognized that the apparatus 300 may be used in connection with a 22 kW, 800V variant assuming that various values for the electrical devices illustrated on the apparatus 200 are utilized. The apparatus 300 may also provide bi-directional energy transfer from the mains supply 106 to the battery 215, and from the battery 215 back to the mains supply 106.

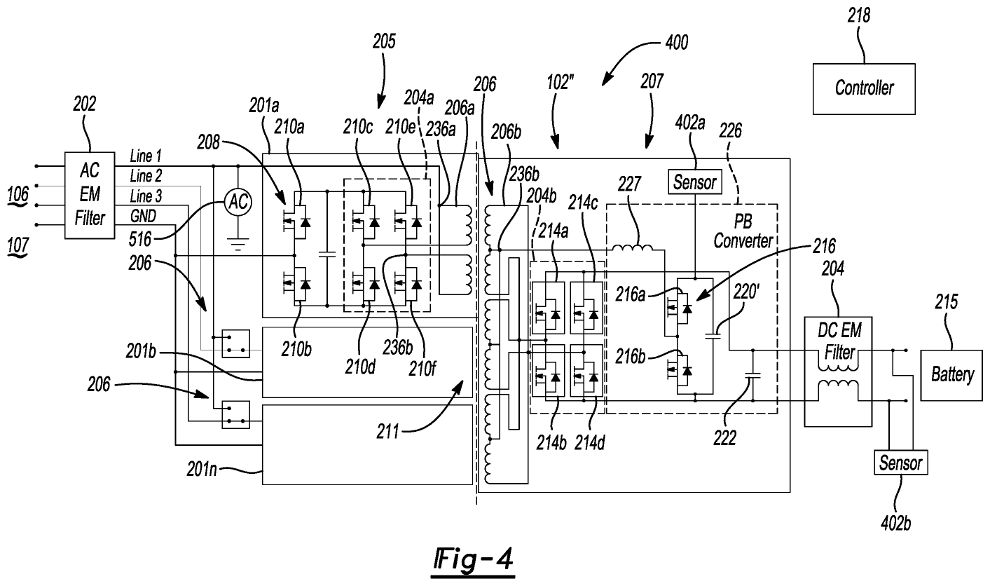

FIG. 4 depicts an apparatus 400 for the single stage OBC 102″ with the integrated PB converter 226 in accordance with one embodiment. The apparatus 400 is generally similar to the apparatus 300 as described in connection with FIG. 3. However, the PB converter 226 includes at least two switches 216a-216b (or hereafter the switches 216a-216b), one or more capacitors 220′ (hereafter “the capacitor 220”), and the inductor 227. The switches 216a-216b form a half-bridge circuit and may be generally defined as a boosting circuit 216. The controller 218 selectively activates and/or deactivates the switches 216a-216b. The capacitor 220′ is coupled to the switches 216a-216b and serves as a high frequency filter to remove high frequency noise attributed to the switching frequency of the switches 214a-214d. In general, the PB converter 226 may provide for energy transfer based on magnetic energy stored on the inductor 227 and electrical energy stored on the capacitor 222. This aspect may be controlled based on the manner in which the controller 218 controls the switches 216a-216b. When either of the switches 216a-216b is closed, current across the inductor 227 is increased and flows through the closed switch 216a-216b to the capacitor 222.

In general, the capacitor 220 as illustrated in connection with FIG. 3 may be larger, bulkier, and/or require more capacitance than the capacitor 220′ as illustrated in connection with FIG. 4. Such a reduction in the size and/or capacitance of the capacitor 220′ is generally attributed to the presence of the switches 216a-216b. For example, the PB converter 226 generally compensates the output as provided by the mains supply 106 (or the grid 107) to the battery 215. The switches 216a-216b increase the output operation range of the PB converter 226. The controller 218 activates one of the switches 216a or 216b while deactivating the other of the switches 216b or 216a. For example, the controller 218 activates one of the switches 216a or 216b at a given frequency irrespective of the direction that that energy flows (e.g., energy flows from the grid 107 to the battery 215 or the energy flows from the battery 215 to the grid 107). The apparatus 400 includes a sensor 402a that measures a voltage at the capacitor 220′. The sensor 402 provides a first signal indicative of the measured voltage to the controller 218. The apparatus 400 also includes a second sensor 402b that measures a voltage that is being produced by the apparatus 400 (e.g., 400V or 800V) and stored on the battery 215, or conversely that is being transmitted back to the grid 107. The second sensor 402b transmits a second signal indicative of the measured voltage to the controller 218. The controller 218 controls the switching frequency (or duty cycle) of the switches 214a-214d and the switches 216a-216b based on measured voltage at the capacitor 220′ and on the measured voltage that is being generated by the apparatus 400 (e.g., the voltage being stored on the battery 215 or being transmitted back to the grid 107). Thus, in this regard, the controller 218 controls the duty cycle of the switches 216a-216b to be similar to the duty cycle of the switches 214a-214d. It is recognized that the PB converter 226 does not provide all of the energy that is being received from the mains supply 106 to the battery 215 during a charging operation. Rather, as energy is being received from the AC grid 107 and being stored on the battery 215, the PB converter 226 provides energy to reduce the ripple or oscillation effects of the overall energy being received from the grid 107 or coming into the circuit from the grid 107. In particular, the PB converter 226 provides energy to reduce the ripple or oscillation effects of the output. The boosting circuit 216 increases the overall voltage operation for the capacitor 220′. Thus, in this regard the PB converter 226 operates the capacitor 220′ at higher voltage to maximize the energy stored therein which is ½ C*V². Therefore, the higher the voltage, a lesser amount of capacitance is required to provide sufficient energy to reduce the ripple on the incoming energy that is being stored on the battery 215 (or to reduce the ripple on the energy that flows from the battery 215 back to the grid 107). The manner in which the OBC 102″ operates in the charging state and discharging state will be described in more detail below.

In the charging state, the OBC 102″ transfers energy from the mains supply 106 to the battery 215 to store the energy on the battery 215. For example, the switches 210a-210f receive the AC energy and generates a high-frequency AC input (e.g., 100 kHz based AC input) that is provided to the primary side 205 of the transformer 206. The transformer 206 increases the high-frequency AC input and provides an increased high-frequency AC input to the switches 214a-214d. The switches 214a-214d (or the DAB stage 204b) convert the AC input as received from the transformer 206 into a DC input that includes oscillations. The current oscillations include a current ripple which corresponds to a residual periodic variation of the DC input which has been derived from the AC input provided to the switches 214a-214d. The PB converter 226 smooths or reduces the current ripple from the DC input provided by the switches 214a-214d prior to the DC input being stored on the battery 215. For example, the boosting circuit 216 increases the amount of voltage that can be stored on the capacitor 220′. This enables the PB converter 226 to reduce the amount of current ripple on the DC input prior to storage on the battery 215. In general, the current ripple exceeds a threshold, the OBC 400 provides a drain to discharge current through the inductor 227 via magnetic energy which then converts the magnetic energy into electric energy for storage on the capacitor 220′. Thus, as the boosting circuit 216 increases the amount of voltage stored on the capacitor 220′, this aspect results in a decrease in the current ripple in the charging state. Also in the charging state, when the current ripple is below the threshold, the capacitor 220′ discharges current into the energy flowing from the switches 214a-214d to the battery 215. Therefore, the net effect of the current being above or below the threshold may reduce the current ripple associated with the output voltage provided by the switches 214a-214d. In the discharging state, the battery 215 transfers energy back to the mains supply 106. For example, the controller 218 controls the battery 215 to discharge DC voltage which passes through the filter 204. In general, the voltage and current from the battery 215 is a DC based voltage and current, respectively. In this regard, it may not be necessary to activate the PB converter 226. The boosting circuit 216 may be deactivated along with the inductor 227 and the capacitor 220′. The switches 214a-214d chop the discharged DC voltage to generate an AC input on the secondary side 207 of the transformer 206. In the discharging state (or mode), the switches 214a-214d excite the secondary side 207 of the transformer 206 such that the secondary side 207 of the transformer 206 is synchronized with the primary side 205 of the transformer 206 (or the DAB stage 204a). The switches 210a and 210b operate as rectifiers and generate, for example, a 50-60 Hz AC waveform.

In the discharging state, the switches 210a-210b on the primary side 205 operate at a frequency of, for example, 100 Hz and reduce the frequency of the AC input provided by the transformer 206 to an AC signal having a frequency of, for example, 50 to 60 Hz. The AC filter 202 filters the AC signal provided by the OBC 400 prior to the AC signal being provided back to the main supply 106

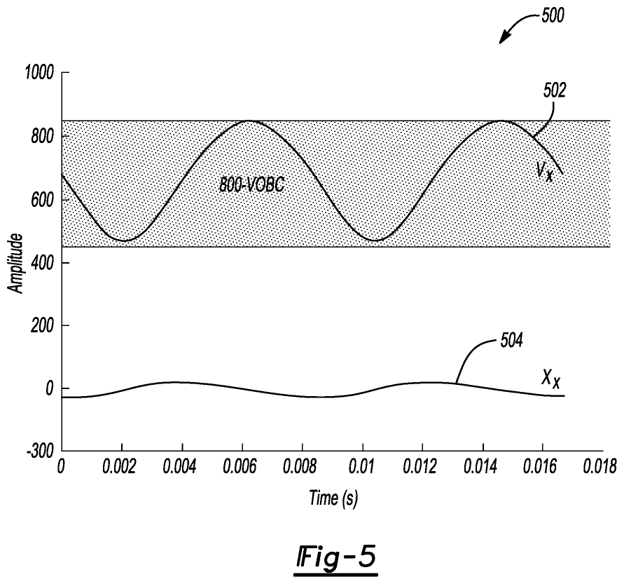

FIG. 5 depicts a plot 500 exhibiting a voltage output associated with the OBC that varies based on time in accordance with one embodiment. Waveform 502 corresponds to the charging voltage of the capacitor 220′. Waveform 504 corresponds to the current flowing through the capacitor 220′. The plot 500 depicts an overall optimization with the PB converter 226 utilizing semiconductors on the secondary side 207 that are rated to 1200V and the capacitor 220′ is rated at 900V. In this instance, the maximum boosted voltage is set to 850V which corresponds to the output of the OBC 400 being in a desired range. In light of the capacitor 220′ being rated to 900V, a working margin for the voltage rating of the capacitor 220′ is provided to enable the voltage to be boosted to 850V

It is recognized that the controllers as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, such controllers as disclosed utilizes one or more microprocessors to execute a computer-program that is embodied in a non-transitory computer readable medium that is programmed to perform any number of the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware-based inputs and outputs for receiving and transmitting data, respectively from and to other hardware-based devices as discussed herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A battery charger comprising:
at least one transformer comprising a first side and a second side;
a first active bridge positioned on the first side, the first active bridge providing a first voltage signal based on an input voltage signal from a mains supply of an electrical grid;
a second active bridge positioned on the second side, the second active bridge providing a second voltage signal, the second voltage signal stored on one or more batteries based on the first voltage signal; and
a pulsating buffer (PB) converter, the PB converter including a plurality of switching devices to interface with the second active bridge, the plurality of switching devices modifying the second voltage signal;
wherein the plurality of switching devices provide a voltage for storage on at least one capacitor of the PB converter while modifying the second voltage signal.

2. The battery charger of claim 1 further comprising: at least one controller configured to activate a first switch of the plurality of switching devices; and to deactivate a second switch of the plurality of switching devices while modifying the second voltage signal.

3. The battery charger of claim 1, wherein the second active bridge provides the second voltage signal, the second voltage signal comprising a current ripple based on the first voltage signal.

4. The battery charger of claim 3, wherein the PB converter reduces the current ripple from the second voltage signal prior to the second voltage being stored on the one or more batteries.

5. The battery charger of claim 1, wherein the second active bridge receives a first battery voltage signal from the one or more batteries, and wherein the first battery voltage signal is indicative of discharged energy from the one or more batteries to the electrical grid.

6. The battery charger of claim 5, wherein the second active bridge generates a first alternating current (AC) input based on the first battery voltage signal prior to discharging energy from the one or more batteries to the electrical grid.

7. The battery charger of claim 6, wherein the second active bridge generates the first AC input at a first frequency based on the first battery voltage signal.

8. The battery charger of claim 7, wherein the first active bridge generates a second AC input at a second frequency that is different from the first frequency based on the first AC input.

9. The battery charger of claim 8, wherein the second AC input is provided to the mains supply of the electrical grid.

10. A battery charger comprising:
at least one transformer comprising a first side and a second side;
a first plurality of switching devices positioned on the first side, the first plurality of switching devices providing a first voltage signal based on an input voltage signal from a mains supply of an electrical grid;
a second plurality of switching devices positioned on second side, the second plurality of switches providing a second voltage signal, the second voltage signal stored on one or more batteries based on the first voltage signal;
a pulsating buffer (PB) converter, the PB converter interfacing with the second plurality of switching devices and modifying the second voltage signal; and
a third plurality of switching devices to provide a voltage stored on at least one capacitor of the PB converter while modifying the second voltage signal.

11. The battery charger of claim 10 further comprising: at least one controller configured to activate a first switch of the third plurality of switching devices and to deactivate a second switch of the third plurality of switching devices while modifying the second voltage signal.

12. The battery charger of claim 10, wherein the second plurality of switching devices provides the second voltage signal, the second voltage signal comprising a current ripple based on the first voltage signal.

13. The battery charger of claim 12, wherein the PB converter reduces the current ripple from the second voltage signal prior to the second voltage signal being stored on the one or more batteries.

14. The battery charger of claim 10, wherein the second plurality of switching devices receives a first battery voltage signal from the one or more batteries, and wherein the first battery voltage signal is indicative of discharged energy from the one or more batteries to the electrical grid.

15. The battery charger of claim 14, wherein the second plurality of switching devices generates a first alternating current (AC) input based on the first battery voltage signal prior to discharging energy from the one or more batteries to the electrical grid.

16. The battery charger of claim 15, wherein the second plurality of switching devices generates the first AC input at a first frequency based on the first battery voltage signal.

17. The battery charger of claim 16, wherein the first plurality of switching devices generates a second AC input at a second frequency that is different from the first frequency based on the first AC input, wherein the second AC input is provided to the mains supply of the electrical grid.

18. The battery charger of claim 11, wherein the PB converter includes an inductor being coupled to the third plurality of switching devices.

19. The battery charger of claim 11, wherein the third plurality of switching devices control energy flow to and from the at least one capacitor.

20. A vehicle battery charger comprising:
at least one transformer;
a first plurality of switching devices providing a first voltage signal based on an input voltage signal from a mains supply of an electrical grid;
a second plurality of switching devices providing a second voltage signal stored on one or more batteries based on the first voltage signal; and
a pulsating buffer (PB) converter including a third plurality of switching devices to interface with the second plurality of switching devices, the third plurality of switching devices modifying the second voltage signal;
wherein the third plurality of switching devices provide a voltage stored on at least one capacitor while modifying the second voltage signal.
